(19) United States
(12) Patent Application Publication
(10) Pub. No.: US 2012/0328279 A1
(43) Pub. Date: Dec. 27, 2012

(54) Shoulder Mounted Camera Support and Stabilizer

(76) Inventor: David Raizman, Burlington, VT (US)

(21) Appl. No.: 13/168,640

(22) Filed: Jun. 24, 2011

(51) Int. Cl. G03B 17/56; A45F 5/00

(52) U.S. Cl. 396/421; 248/205.1

(57) ABSTRACT

The disclosed invention provides simultaneous hands-free support, stability and control of heavy loads comfortably upon the body over extended periods of time; while being both convenient to take on and off, without reducing operator mobility. Through the efficiency associated with cantilever design principles, the invention balances and transfers a load comfortably across the body. As a load is placed on a resting device, such as a camera resting on a camera mount, the load is balanced by an equal and opposite force firmly pressing against the user's hip, with the shoulder performing the pivoting function of a fulcrum. The shoulder mounted invention represents an ergonomic improvement over existing products by providing a totally hands-free experience coupled with a unique interface with the user's body.

### CROSS-REFERENCE TO RELATED APPLICATIONS

Not Applicable

### STATEMENT REGARDING FEDERALLY SPONSORED RESEARCH

Not Applicable

### SEQUENCE LISTING OR PROGRAM

Not Applicable

### BACKGROUND OF THE INVENTION

1. Field of the Invention

This invention relates to mobile support structures or support systems, particularly to hands-free support and stability of a video camera or other body carried equipment, comfortably on an operator's body. In the filmmaking and video production industries, video camera operators must simultaneously achieve mobility while supporting and stabilizing a video camera with precise control. In other words, camera operators desire a hands-free device that can instantly be applied to or removed from the body while simultaneously shooting and supporting a camera or other similar device. The invention solves the problem of excessive camera weight resulting in muscle fatigue, reduced mobility, and the inability to achieve smooth, steady, controlled videography.

2. Description of Related Art

The invention solves the problem of simultaneously achieving hands-free operation, mobility and comfort, freedom of movement, support, stability, and adjustability of a video camera or other body mounted or handheld device. A traditionally accepted method of supporting and stabilizing a portable video camera or similar shoulder mounted device is achieved by mounting such device on a stationary tripod, or by placement of the device on or against a stationary object such as a wall. While tripod mounted devices solve the problem of support and stabilization, they do not lend themselves to mobility in the sense of hands-free operation or ease of installation and removal. Because tripods are oftentimes heavy, large, intrusive, require space to set up, and may be awkward to flexibly maneuver; it is difficult for the camera operator to achieve the mobility, unobtrusiveness and comfort necessary to accomplish quality video recordings. The invention solves this problem by providing the camera operator or the operator of alternative handheld, shoulder mounted or body supported device(s) with the mobility to move freely about, while simultaneously achieving the support, stability and hands-free control of the device necessary to ensure a quality output.

The invention achieves the objective of comfort by minimizing muscle fatigue while maximizing camera flexibility, adjustability and control through efficient design. The invention also does not interfere with the operator's natural range of movement and allows for completely hands-free operation of the camera. Traditionally, video camera operators have been required to carry heavy, oftentimes awkward devices from location to location to capture a video scene. Temporary support of the device upon the operator's body or in the operator's hands places the center of gravity of the device forward of the operator, requiring the operator to balance this force with opposing body movements and muscle control. Repeated lifting and lowering of the unsupported device results in a constantly shifting center of gravity, placing great strain on the muscles and body of the operator. Current solutions may employ a horizontal shoulder brace supported by the arms and hands of the camera operator and may employ one or two hand grips. This type of system stabilizes the camera but doesn't support the weight of the camera. Alternative solutions place a large a weight behind the camera operator to counterbalance the weight of the camera, further adding to the problem of excessive weight. The proposed invention solves these problems via enhanced lightweight materials, efficient ergonomic design, resulting in a comfortable, and hands-free operating experience.

The invention achieves the objective of portability through its lightweight design and inherent ability to be quickly installed or removed from the body of the operator. Typically, the prior art provides some form of a horizontal shoulder brace or harness connected to a vertical rod or post extending directly beneath the camera to the operator's waist. The rod is either affixed to a belt around the operator's waist or simply presses against the waist. While the current art solves the problem of achieving temporary support for shoulder mounted devices, the fixed nature of these devices which relies on belts, straps, and harnesses achieves an acceptable stationary solution, but does not lend itself to photographing events which are constantly in motion. The relatively massive size of these devices positioned directly in front of the user reduces comfort and mobility. The existing solutions limit the operator's mobility and flexibility impeding his/her ability to move quickly as in a football game or other fast moving sporting event. The light weight, quick setup/removal, and hands-free capability of the proposed invention overcomes the deficiencies of the prior art in achieving these competing objectives.

### SUMMARY OF THE INVENTION

The present invention includes camera support devices and solves the problem of simultaneously supporting, controlling and stabilizing a video camera or other body mounted or handheld device by a human operator who requires hands-free mobility and comfort over extended periods of usage. In the preferred embodiment, the present invention includes a rotating, three dimensional, configurable Camera Arm and Camera Mount providing multiple adjustments for camera height, distance from the operator, alignment in front of the operator, camera angle, and controlled camera rotation. The invention's design parameters were established in accordance with the engineering principles associated with a cantilever yielding the desired hands-free objective. A projecting, rigid, and configurable horizontal Camera Arm acts as a simple lever, and carries a load that is supported and suspended in front of the user's body. A Shoulder Support resting on the operator's shoulder acts as a fulcrum, while the Vertical Spine and Hip Stabilizer provide the counterbalancing load in an ergonomically unique design. The weight of the camera resting on the cantilevered Camera Arm causes the device to function as a clamp or clasp, securing and tightening the device firmly to the operator's body. A solid connection is formed between the invention and the operator's body so that no extraneous belts or harnesses are required to keep the invention secured comfortably to the operator's body while moving about. The subsequent balance, security, and stability associated with the design of this invention yields the desired hands-free operation.

The Camera Arm is attached to a configurable support apparatus (the “Vertical Spine”) that begins at the Shoulder Support resting on the operator's shoulder, transitions from the Shoulder Support down along the operator's back, transitioning from the operator's back to the Hip Adjustment, and transitions from the Hip Adjustment to the user's front side, terminating at the Hip Stabilizer directly on the operator's front hip. The Camera Arm, Shoulder Support, Vertical Spine, Hip Adjustment and Hip Stabilizer will be built of specialty engineered materials to minimize weight and maximize strength relative to existing solutions. The Shoulder Support will use specialty padding materials to enhance the overall comfort of the invention.

In the preferred embodiment, the invention assumes that the Shoulder Support rests on the Operator's right shoulder and the Hip Stabilizer rests on the operator's right hip. Alternative embodiments include a Shoulder Support resting on the right shoulder accompanied by a Hip Stabilizer resting on either the right or left hips; or a Shoulder Support resting on the left shoulder accompanied by a Hip Stabilizer that can rest on either the right or left hips. Alternative embodiments include variations on the design of the Shoulder Support to include a Double Shoulder Support, resting on both shoulders, accompanied by a Hip Stabilizer that rests on either the right or left hips.

In one embodiment, the invention will be manufactured with no adjustments for various body shapes and sizes, and will simply be offered in a variety of fixed sizes sufficient to accommodate operators of varying body sizes. In alternative embodiments, the invention will be manufactured with multiple adjustments providing single solution flexibility to accommodate multiple users. For example, the invention will have adjustments to modify the length of the Vertical Spine along the operator's back, adjustments to modify the width of the Vertical Spine across the operator's back, adjustments to modify the width of the Vertical Spine along the operator's side, and adjustments to the rotation angle and position of the Hip Stabilizer. In some embodiments, the range of movement of the Camera Arm pivot the rotation angle of the Camera Arm and Camera Mount may be an entire 360 degree range of motion, while in other embodiments, a stop may be provided to limit the range of motion about the axis.

The preferred embodiment of the invention will include a collapsible hinge point between the Shoulder Support and Vertical Spine, and another collapsible hinge point between the Vertical Spine and Hip Stabilizer. The inclusion of hinge points allows the invention to be quickly installed and removed. Collapsibility improves the flexibility and portability of the invention by allowing it to be quickly installed, removed, carried from location to location, and fit more easily into a bag for stowage or travel.

For operators requiring an added degree of stability and support, an alternative embodiment of the invention will exclude the Hip Adjustment and Hip Stabilizer, and replace them with a telescoping Vertical Spine along the back of the operator. The Vertical Spine will simply terminate into a cinching mechanism on a belt specially designed to be held fast around the operator's waist.

Alternative embodiments of the invention will include alternatives to the Camera Arm. The Camera Arm and Mount will be replaced with any number of specialty designed mounts that will be configured to attach to the Shoulder Support and Vertical Spine in all its configurations. Specialty mounts are comprised of mounts facilitating the carrying of audio boom poles, microphones, infants, building supplies, heavy buckets or other large items requiring lateral and longitudinal support on an operator's body.

### DESCRIPTION OF DRAWINGS

FIG. 1 is a sketch of a right side view of an illustrative embodiment of the invention, including Camera Arm, Camera Mount, Shoulder Support, Vertical Spine leading to the Hip Adjustment and Hip Stabilizer. The Vertical Spine runs along either the spine, or between the spine and scapula of the operator.

FIG. 2 is a sketch of a left side view of an illustrative embodiment of the invention, including Camera Arm, Camera Mount, Shoulder Support, Vertical Spine leading to the Hip Adjustment and Hip Stabilizer. The Vertical Spine runs along either the spine, or between the spine and scapula of the operator.

FIG. 3 is a sketch of a left side detailed view of the invention revealing placement and function of various quick release levers.

FIG. 4 is a sketch of a left side detailed view of the Shoulder Support

FIG. 5 is a sketch of the top view of an illustrative embodiment of the invention

FIG. 6 is a sketch of a detailed top view of the invention including adjustments

FIG. 7 is a sketch of a detailed front view of the invention

FIG. 8 is a sketch of an alternative embodiment of the invention (Shoulder Support resting on right shoulder and Hip Stabilizer on left hip).

FIG. 9 is a sketch of an alternative embodiment of the invention (Shoulder Support resting on left shoulder and Hip Stabilizer on left hip).

FIG. 10 is a sketch of an alternative embodiment of the invention (Shoulder Support resting on left shoulder and Hip Stabilizer on right hip).

FIG. 11 is a sketch of an alternative embodiment of the invention (Double Shoulder Support resting on both shoulders, accompanied by Hip Stabilizer resting on either hip).

FIG. 12 a sketch of the back view of an illustrative embodiment of the invention.

FIG. 13 is a sketch of an illustrative embodiment of an adjustable Vertical Spine including illustrative hinge points and quick release features.

FIG. 14 is a sketch of an illustrative embodiment of the Vertical Spine with collapsible hinge points.

FIG. 15 is a sketch of an alternative embodiment of the Vertical Spine including modified Hip Stabilizer.

FIG. 16 is a sketch of an alternative embodiment of the invention whereby the Camera Mount is replaced with a specialty mount for carrying audio boom poles and/or microphones.

FIG. 17 is a sketch of an alternative embodiment of the invention whereby the Camera Arm and Camera Mount are replaced with a specialty mount for the carrying of infants.

FIG. 18 is a sketch of an alternative embodiment of the invention whereby the Camera Mount is replaced with a specialty mount for the carrying of heavy buckets or other heavy materials.

### REFERENCE NUMERALS

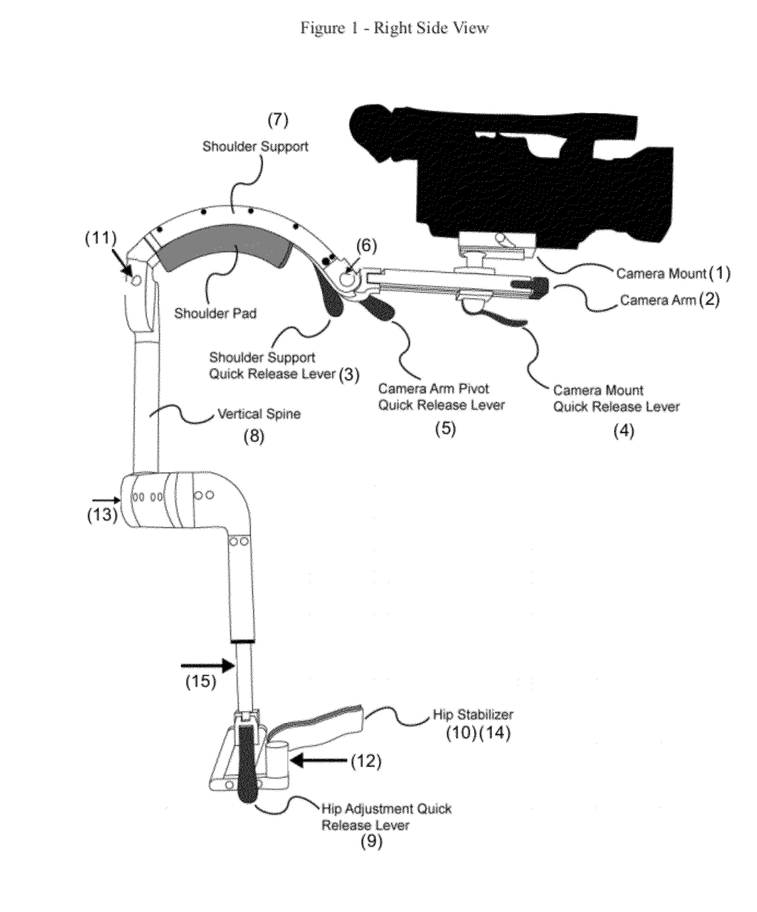

### Refer to FIGS. 1, 6, and 14

(1) Camera Mount
(2) Camera Arm
(3) Quick Release Adjustment on Shoulder Support
(4) Quick Release Adjustment on Camera Mount Controlling Distance from Operator (Depth)
(5) Quick Release Adjustment on Camera Arm Pivot Controlling Position in Front of Operator
(6) Camera Arm Pivot
(7) Shoulder Support
(8) Vertical Spine
(9) Quick Release Adjustment on Hip (i.e. “Hip Adjustment”)
(10) Hip Stabilizer
(11) Collapsible Hinge Point between Shoulder Support and Vertical Spine
(12) Rotating Hinge Point between Hip Adjustment and Hip Stabilizer
(13) Vertical Spine Horizontal Back Adjustment
(14) Modified Hip Stabilizer
(15) Height Adjustment Controlling Height of Hip Adjustment & Hip Stabilizer

### DETAILED DESCRIPTION OF THE INVENTION

The following detailed description should be read with reference to the drawings. The drawings depict illustrative embodiments and are not intended to limit the scope of the invention. Unless specifically stated otherwise, all “References” denoted above refer to References depicted in FIG. 1. Lastly, the drawings are illustrative in nature, are not engineering grade, and are not to scale.

The invention solves the problem of a human operator supporting, stabilizing and controlling heavy loads comfortably upon the body over extended periods of time through the use of a device that simultaneously provides hands-free operation and is both convenient to take on and off without reducing operator mobility. The invention represents an ergonomic improvement over existing products designed to be worn by a human operator requiring hands-free control, mobility, comfort, support and stability of a video camera or other handheld and shoulder mounted device during extended periods of use.

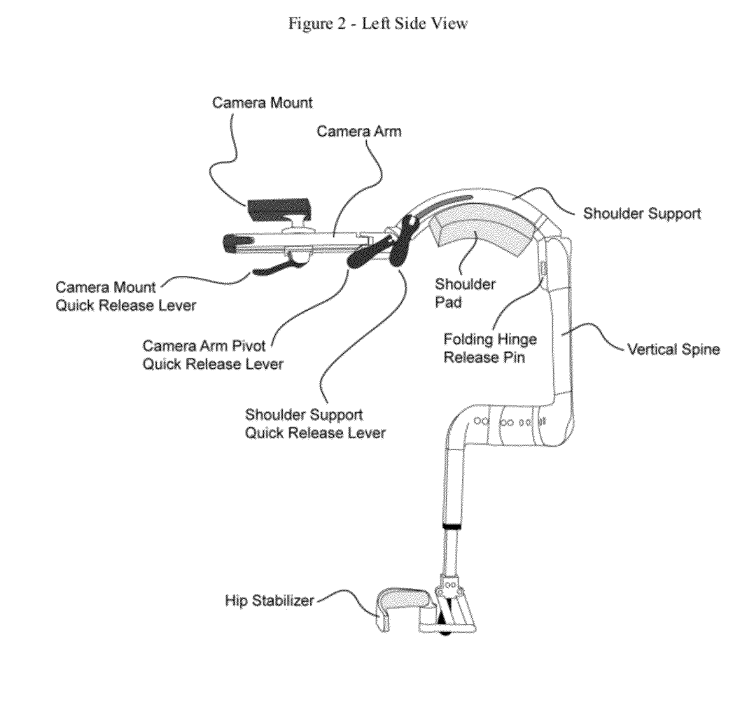

In the right side view of the preferred embodiment, FIG. 1, a primary objective of the invention is to provide the operator with the mobility to move freely about, while simultaneously achieving the support and stability of the device ultimately allowing “hands-free” operation. FIG. 2 provides a left side view of the preferred embodiment. Based on its ergonomically improved design, the invention provides for the full weight of a camera, or other alternative load upon the shoulder mounted device, to be transferred from the cantilevered Camera Arm (2) into the shoulder and the front of the hip. The Shoulder Support (7) acts as a fulcrum with the hip acting as a counter-balance to the weight of the applied load. There exists a Quick Release Adjustment (3) on the Shoulder Support providing for an extension of the Shoulder Support itself. The extended arm exists within the radius of the Shoulder Support and allows adjustment for the operator to achieve optimal balance of the load upon the body, and to more accurately establish the height of the Camera Arm (or any other load bearing device upon the Mount). When the invention is adjusted properly, the arms and hands of the operator are not required to support the camera. When the invention is properly configured, the operator can shoot video without holding the camera resulting in a completely hands-free operation. No other existing support and stabilization invention borrows as heavily from the engineering principles associated with a cantilever, nor do any other competing inventions use the hip and shoulder in such an ergonomic manner to support the cantilevered load.

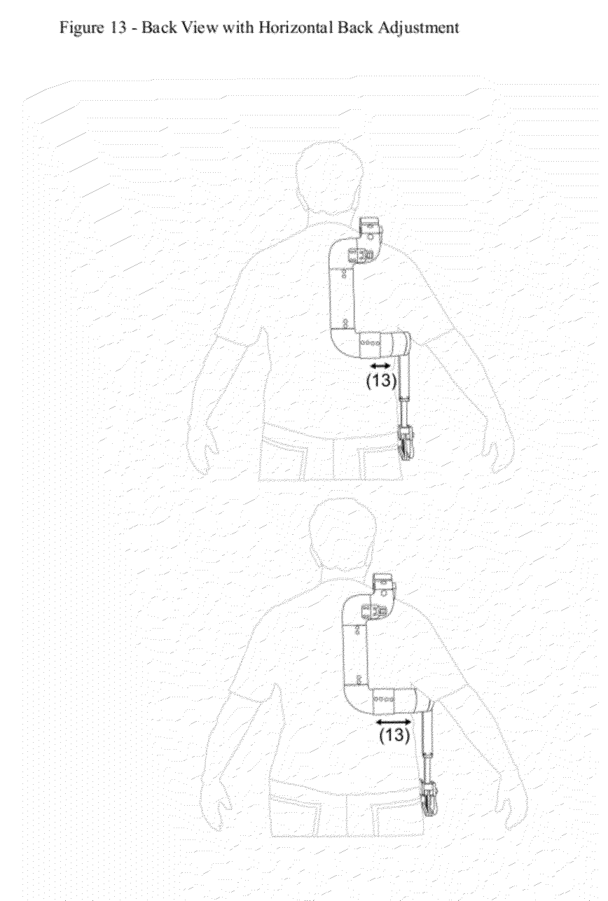

Another objective of the invention is to provide maximum comfort to the operator and to accommodate multiple devices operated by users of various sizes. This is achieved by “quick configuration” adjustments built into the design of the invention itself and by reducing the weight of the invention relative to existing products. In the preferred embodiment where adjustments are included, the invention will be manufactured with multiple adjustments providing single solution flexibility to accommodate multiple users. These adjustments provide the flexibility for the invention to fit securely and firmly against the operator's body, further increasing stability and control. In this embodiment, the invention will provide adjustments to the horizontal width of the Vertical Spine along the operator's back (13), also referred to as the Horizontal Back Adjustment, (FIG. 13—Reference (13)), which provides flexibility to accommodate operators of various hip sizes. The invention provides an adjustment to modify the height of the Hip Adjustment and Hip Stabilizer along the operator's side (15), and adjustments via the Hip Adjustment Lever (9) controlling the position, firmness, and rotation of the Hip Stabilizer (10), (14). In some embodiments, the range of movement of the rotation angle may be an entire 360 degree range of motion, while in other embodiments, a stop may be provided to limit the range of motion about the axis (12).

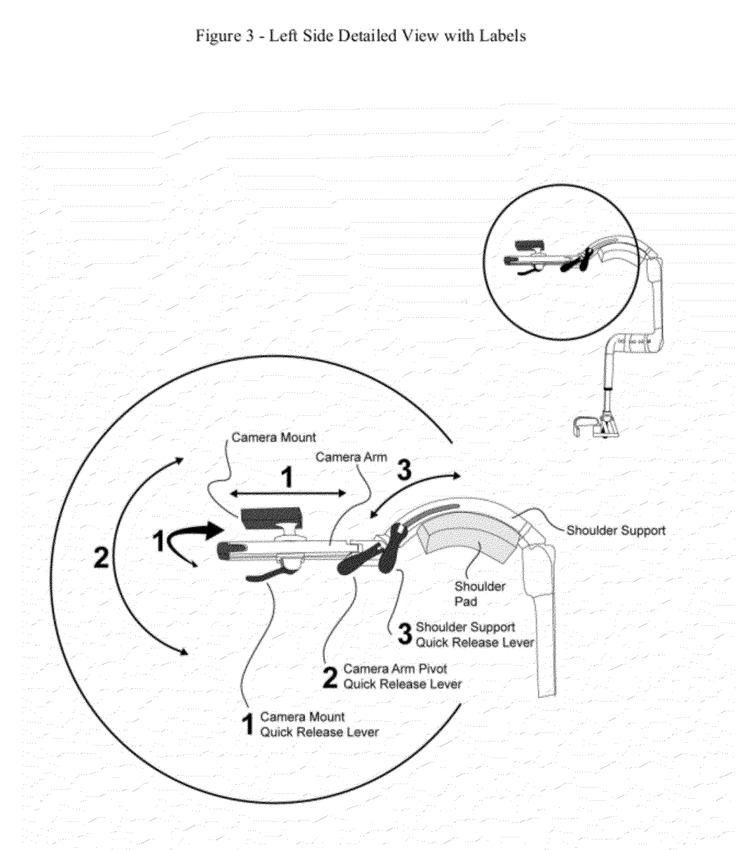

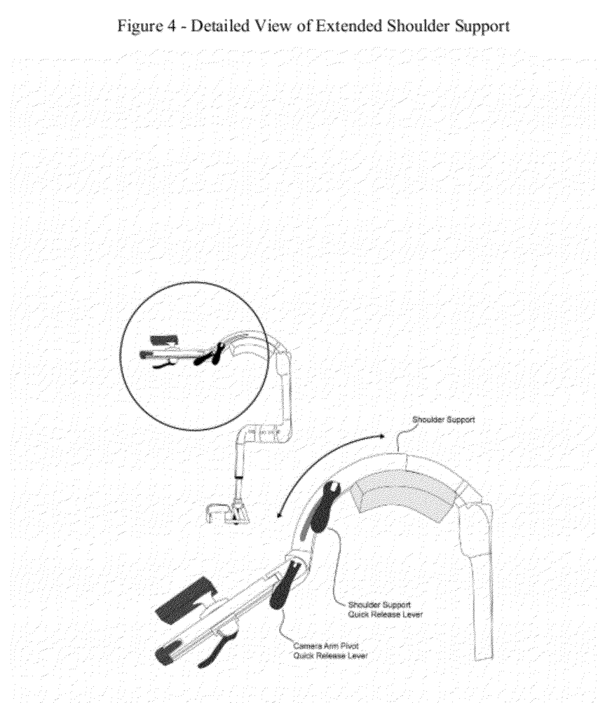

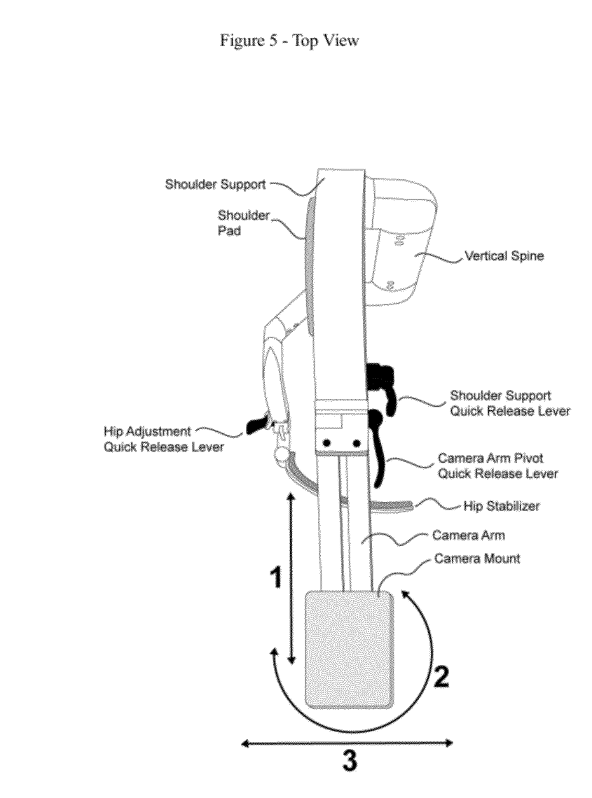

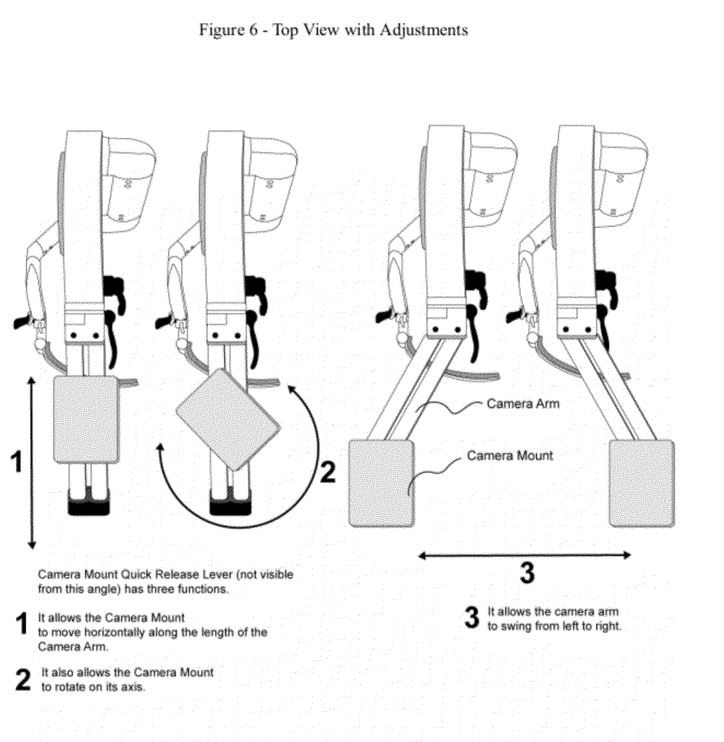

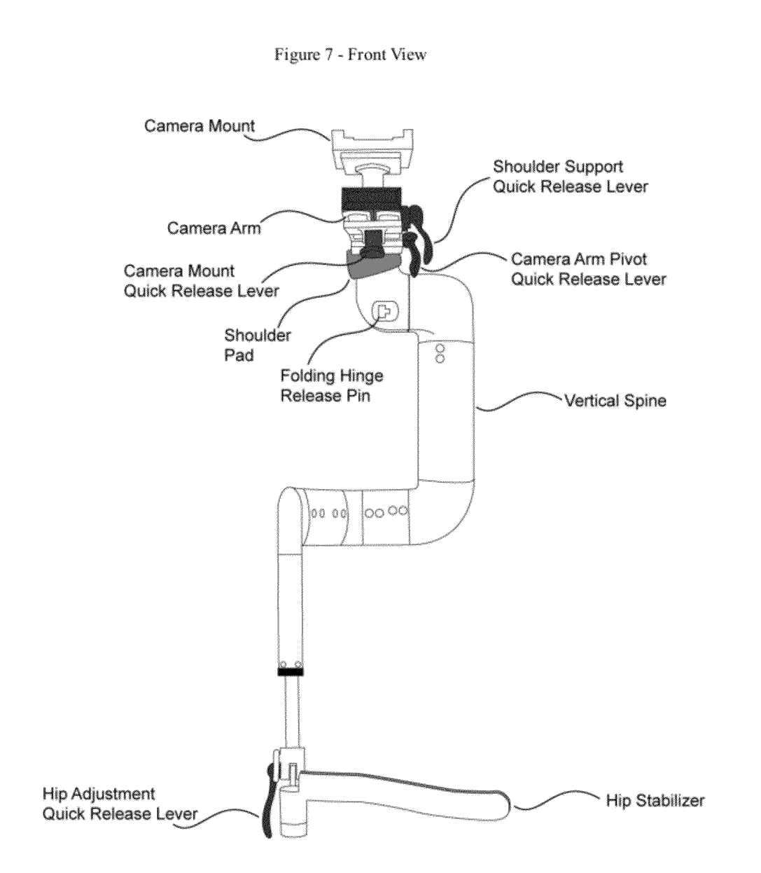

In the preferred embodiment displayed in FIG. 1, the invention is comprised of a rotating, three dimensional, flexible Camera Arm (2) and Camera Mount (1) attached to an adjustable Shoulder Support (7) providing multiple adjustments. These adjustments are comprised of a Quick Release (3) on the Shoulder Support to control vertical distance of the applied load relative to the Operator; a Quick Release (4) on the Camera Mount to control the distance of the camera away from the operator, also referred to as camera depth; an extension adjustment (13) on the horizontal axis of the Vertical Spine primarily providing security and firmness for operators of various sizes, but also to assist in the positioning of the camera across the front of the operator; a pivoting Camera Mount (1) allowing fine control of camera angle; and a separate Quick Release (5) on the Camera Arm just below the Shoulder Support controlling rotation angle of the Arm itself, such rotation angle comprised of a drag or a spring mechanism to prevent the Mount from dropping too quickly (6). FIG. 4 provides an alternative, detailed view of the Shoulder Support Quick Release (5) and its associated function. FIG. 3 provides a left side, alternative, detailed view of each of the Quick Release functions described above. FIG. 5 provides an illustrative, alternative top view of the invention. FIG. 6 provides an illustrative, alternative top view of the invention highlighting the wide range of motion of the Camera Arm and Camera Mount. Lastly, FIG. 7 provides and illustrative view of the invention as viewed from the front.

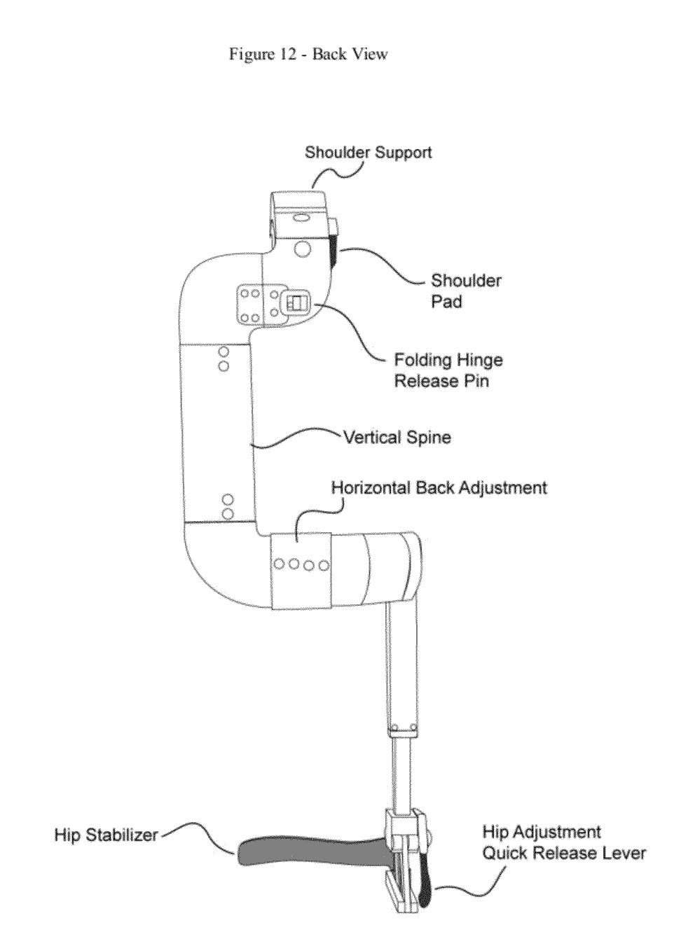

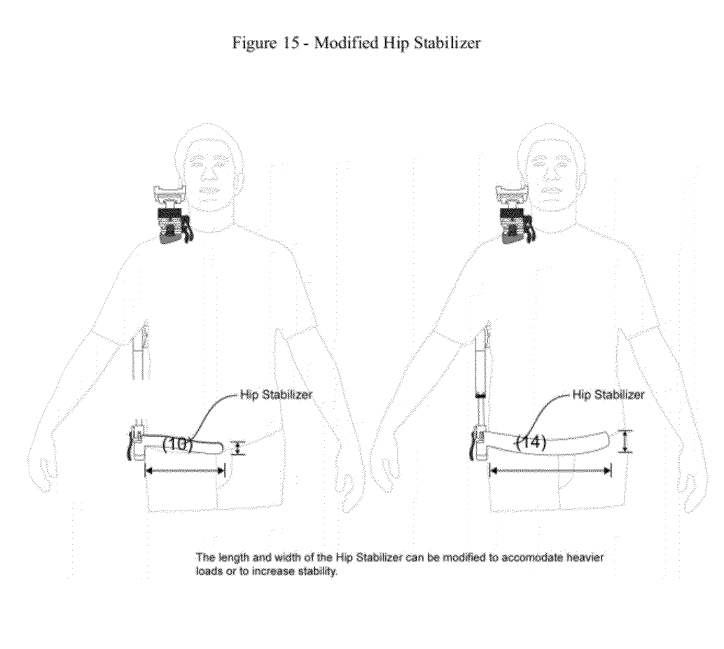

The Camera Arm is attached to a flexible support apparatus referred to as the Vertical Spine (8) that begins at the Shoulder Support (7) resting on the operator's shoulder, transitions from the Shoulder Support to the Vertical Spine (8) running down along the operator's back, transitions from the Vertical Spine to the Hip Adjustment (15) on the side of the operator's body, and terminates from the Hip Adjustment to the Hip Stabilizer (10), (14) directly on the operator's front hip. The length and/or width of the Hip Stabilizers can be modified to accommodate loads of varying sizes, or to increase load stability. FIG. 15, References (10) and (14) provide illustrative, alternative embodiments of the invention comprising Hip Stabilizers of various designs. FIGS. 12 and 13 provide additional detail regarding the function of the Horizontal Back Adjustment (13). FIG. 12 is an illustrative sketch of the back view of the invention highlighting the exact position of the Horizontal Back Adjustment (13), while FIG. 13 provides an illustrative view of the horizontal movement of the Horizontal Back Adjustment. The horizontal movement provides flexibility in the position of the horizontal axis of the Vertical Spine which controls the left to right tilt angle of the overall invention. In addition to controlling the tilt angle of the invention, the Horizontal Back Adjustment enhances the “user experience” by providing the operator with the necessary control over comfort and fit by allowing the operator to adjust the invention to his/her unique physical size.

The Hip Adjustment contains a separate Hip Adjustment Quick Release Lever (9) providing additional control over fit and function. This Quick Release Lever provides adjustment of the vertical distance of the Hip Stabilizer (10), (14) along the hip of the operator's body, as well providing adjustment to accommodate the operator's body thickness as measured from front to back. Similar to the Horizontal Back Adjustment (13), the Hip Adjustment Quick Release Lever (9) enhances the “user experience” by providing the operator with the necessary control over comfort and fit by allowing the operator to adjust the invention to his/her unique physical size.

The Shoulder Support (7) will use specialty padding materials to enhance the overall comfort of the invention. The padding is used to cushion the interfaces at the shoulders, hips, back and waist. Specialty padding materials are comprised of high density foam, low density foam, open foam, closed foam, rubber, gel, and fabrics. The Camera Arm, Shoulder Support, Vertical Spine, Hip Adjustment and Hip Stabilizer will be built of specialty engineered materials to minimize weight and maximize strength relative to existing solutions. High strength, light weight materials are comprised of aluminum, carbon fiber, carbon fiber composites, ceramics, and other engineered composite alternatives. The Vertical Spine of the invention can have industry standard shelves, pockets, holes and brackets where batteries and other accessories may be mounted. The body of the invention may also have wiring embedded in its structure to simplify connecting batteries and other accessories to the camera.

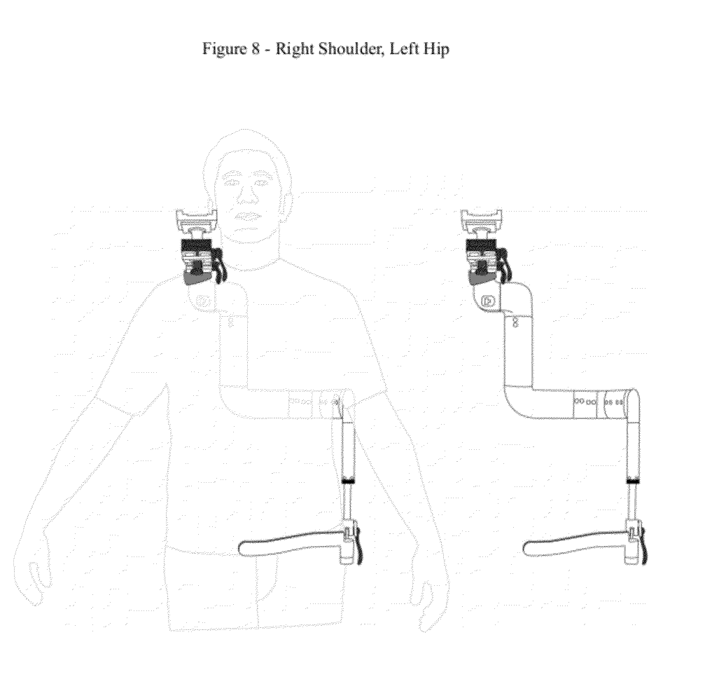

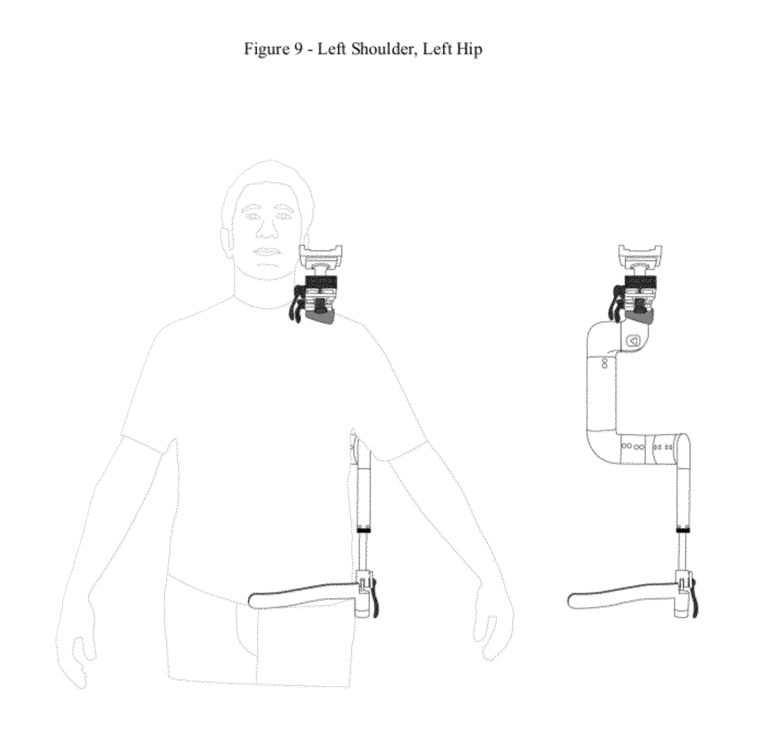

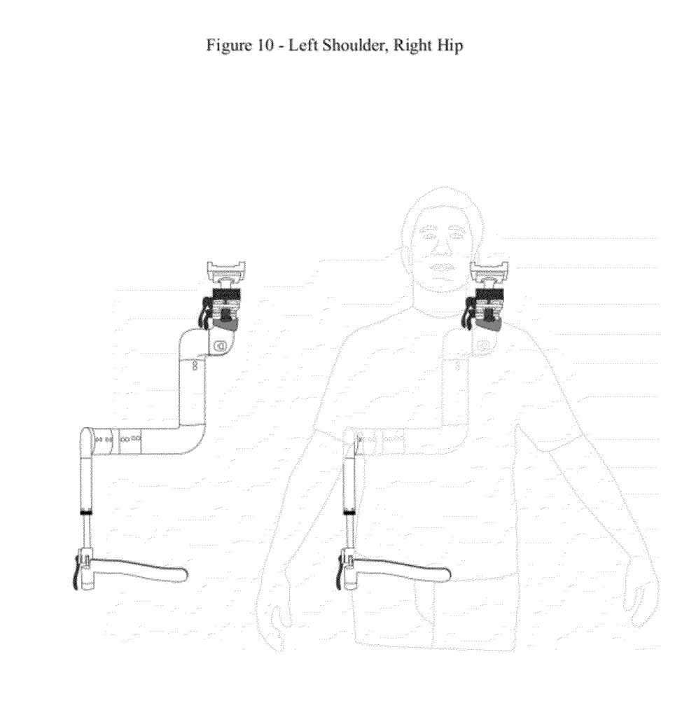

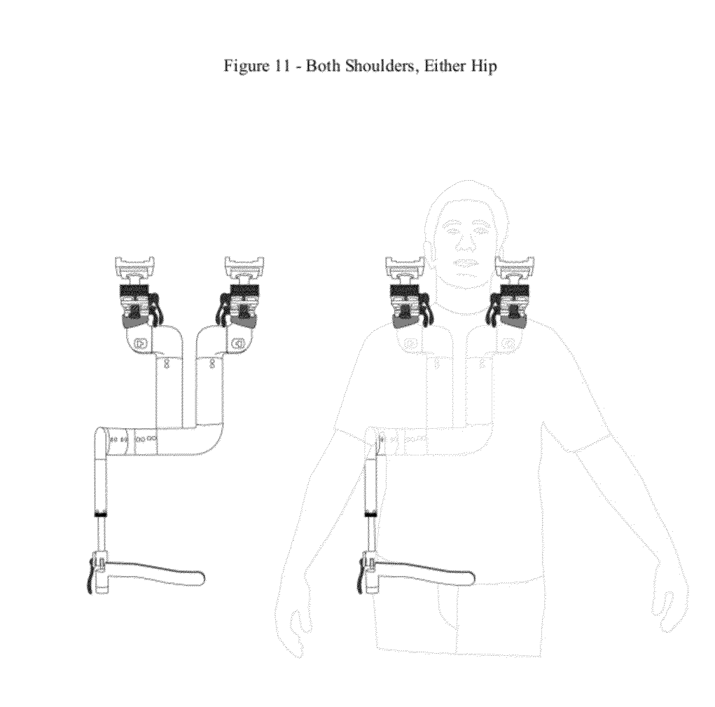

In the preferred embodiment, the invention assumes that the Shoulder Support rests on the Operator's right shoulder and the Hip Stabilizer rests on the operator's right hip (FIG. 1, FIG. 2). Alternative embodiments include a Shoulder Support resting on the right shoulder accompanied by a Hip Stabilizer resting on the left hip (FIG. 8); or a Shoulder Support resting on the left shoulder accompanied by a Hip Stabilizer that can rest on either the left or right hips (FIG. 9, FIG. 10). Alternative embodiments include variations on the design of the Shoulder Support to include a Double Shoulder Support, resting on both shoulders, accompanied by a Hip Stabilizer that rests on either the right or left hips (FIG. 11).

The basic form can be modified by extending and widening the Hip Stabilizer that wraps around the hip and across the torso. This will increase the weight load that can be comfortably supported. The Vertical Spine of the invention can come straight down along the spine (FIG. 1, FIG. 2) or it can come down the back between the spine and the scapula. This allows for a lower profile design and still provides the necessary stability. Similarly, the various other elements of the invention can be modified depending on the load being supported, which is a direct function of the types of devices being supported.

In its simplest form, an alternative embodiment of the invention can function with no “quick configuration” adjustments at all. It can come in a variety of basic sizes including small, medium, large or extra large; depending upon different body types of the operator(s). In this embodiment, the invention will be manufactured with no adjustments and will simply be offered in a variety of fixed sizes sufficient to accommodate operators of varying body sizes.

For operators requiring an added degree of stability and support, an alternative embodiment of the Vertical Spine may be attached to the wearer's hip by means of a belt, with a rigid or flexible member extending down the wearer's back from the padded member extending over the wearer's shoulder(s). In this alternative embodiment of the invention, the Hip Adjustment and Hip Stabilizer are replaced with a telescoping Vertical Spine along the backside of the operator. The Vertical Spine terminates into a cinching mechanism on a belt specially designed to be held fast around the operator's waist. Padding, as previously described, may be used to cushion the interfaces at the shoulder and waist or hip.

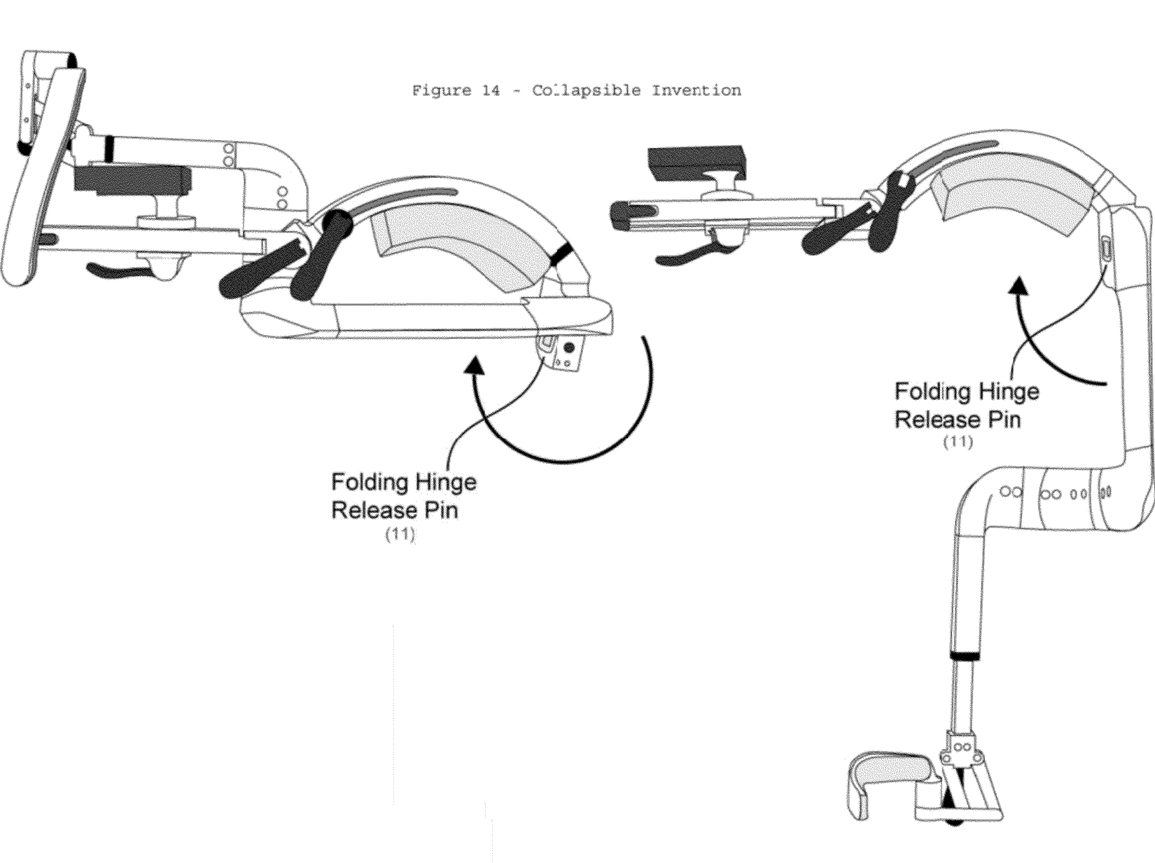

Another objective of the invention is rapid installation and removal of the invention. The preferred embodiment of the invention will include a collapsible hinge point between the Shoulder Support and Vertical Spine (11) (See also FIG. 14—Reference (11)), a rotating hinge point between the Hip Adjustment and Hip Stabilizer (12), and another rotating pivot point between the Camera Arm and the Shoulder Support (6). The inclusion of hinge points allows the invention to be quickly installed, adjusted, then promptly removed. Collapsibility improves the flexibility and portability of the invention by allowing it to be quickly installed, removed, carried from location to location, and fit more easily into a bag for stowage or travel (FIG. 14).

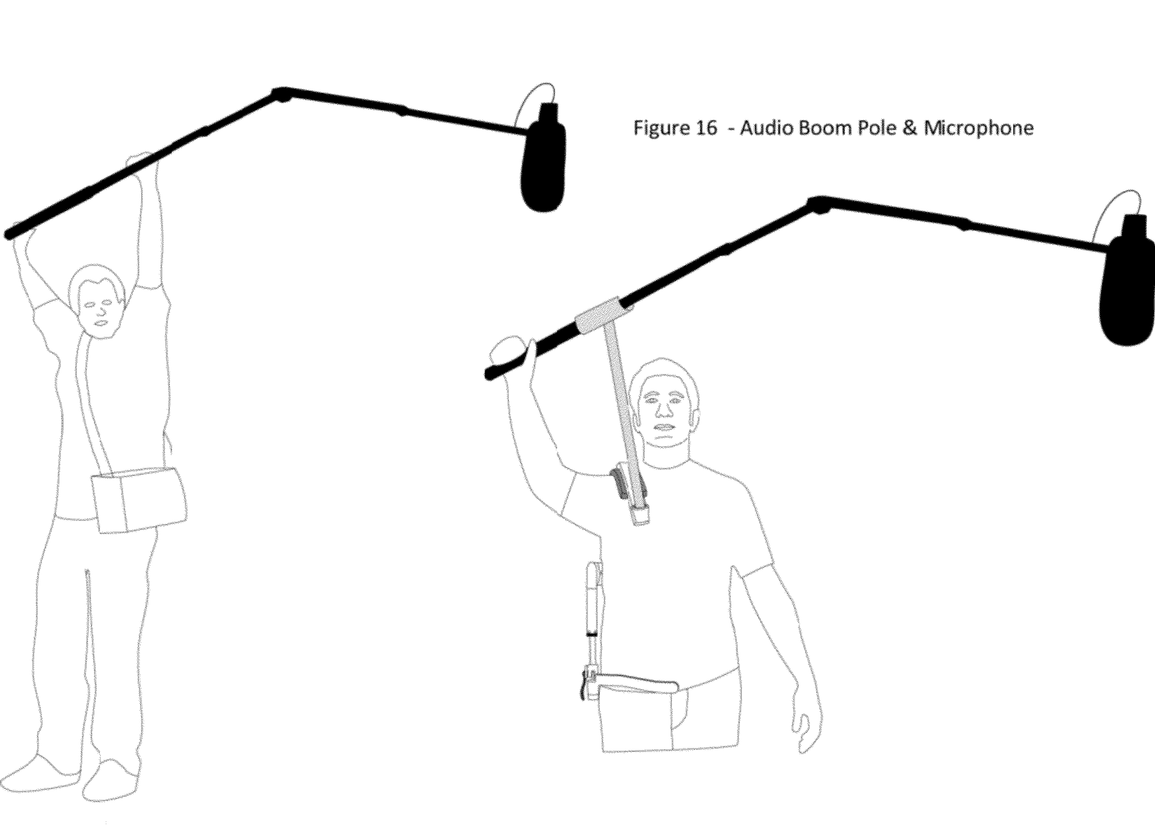

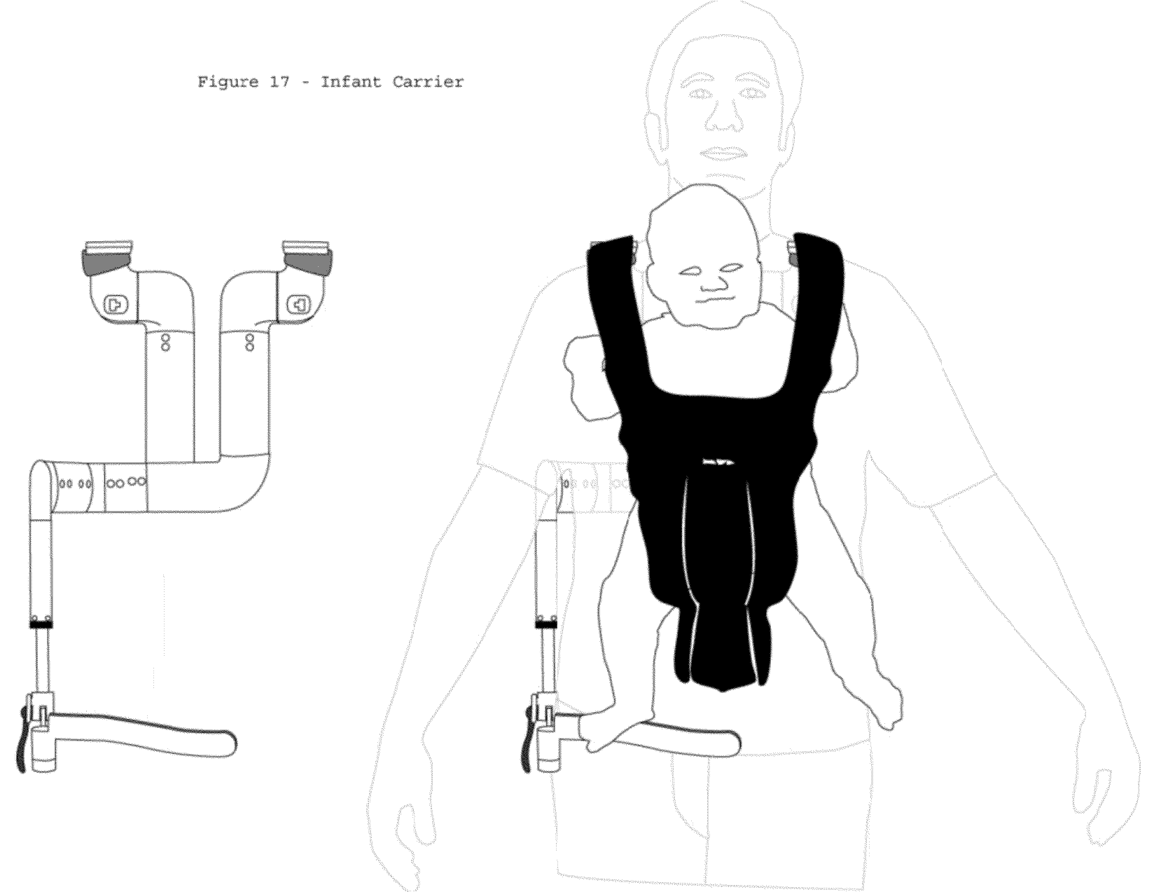

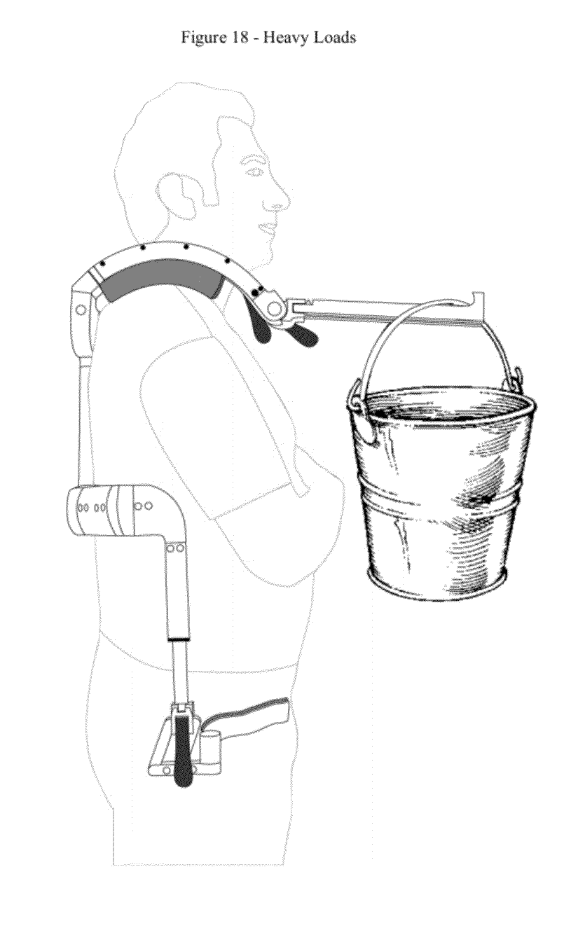

Alternative embodiments of the invention will replace the camera mount with specialty purpose mounts for various other applications. The Camera Arm/Mount alternatives are comprised of specialty designed mounts that will be configured to attach to the remaining elements of the invention in all its configurations. Specialty mount alternatives are comprised of mounts facilitating the support of audio boom poles, microphones (FIG. 16), infants (FIG. 17), building supplies, heavy buckets or other large items requiring lateral and longitudinal support on an operator's body (FIG. 18).

I claim:

1. An apparatus comprising a mount, and a means for redistributing and balancing across the body a load upon the mount including one of more adjustable support members providing hands-free control of a device upon the mount.

2. The apparatus of claim 1 wherein the load upon the mount comprises a camera.

3. The apparatus of claim 1 wherein the means for redistributing and balancing a load across the body comprises a load transfer device straddling the body between the shoulders and the hip.

4. The apparatus of claim 1 wherein the load transfer device comprises an adjustable mount.

5. The apparatus of claim 4 wherein the adjustable mount comprises quick adjustments to control mount height, distance from operator, alignment in front of operator, mount angle, or mount rotation.

6. The apparatus of claim 1 wherein the load transfer device comprises adjustments, quick releases and collapsible hinge points.

7. The apparatus of claim 6 wherein a quick release exists between the mount and shoulder support to control extension of the mount, an adjustment exists along the horizontal axis of the vertical portion of the load transfer device traversing the operator's back, and a quick release exists between the vertical portion of the load transfer device and the hip adjustment to control the height of the hip stabilizer.

8. The apparatus of claim 7 wherein collapsible hinge points are comprised of a pivoting axis between the arm and the shoulder support, a pivoting axis between the shoulder support and vertical portion of the load transfer device, a pivoting axis between the vertical and horizontal sections of the vertical portion of the load transfer device, and a pivoting axis between the hip adjustment and hip stabilizer sections of the load transfer device.

9. The apparatus of claim 1 wherein the load transfer device is quickly installed and removed from the body without the need for adjoining belts or harnesses.

10. The apparatus of claim 1 wherein the load transfer device is comprised of high strength and light-weight materials.

11. The apparatus of claim 10 wherein the load transfer device is comprised of aluminum, titanium, or lightweight, non-ferrous, composite materials.

12. The apparatus of claim 1 wherein the load transfer device is padded at specified load bearing points along the body for increased personal comfort.

13. An apparatus comprising a mount, and a means for redistributing and balancing across the body a load upon the mount wherein the apparatus is fixed or includes one of more adjustable support members providing hands-free control of a device upon the mount.

14. The apparatus of claim 13 wherein the means for redistributing and balancing a load across the body comprises a load transfer device straddling the body between the shoulders and the hip.

15. The apparatus of claim 14 wherein the load transfer device is of a fixed size without any adjustments.

16. The apparatus of claim 13 wherein the load transfer device is quickly installed and removed from the body without the need for adjoining belts or harnesses.

17. The apparatus of claim 13 wherein the load transfer device is comprised of high strength and lightweight materials.

18. The apparatus of claim 17 wherein the load transfer device is comprised of aluminum, titanium, or lightweight, non-ferrous, composite materials.

19. The apparatus of claim 13 wherein the load transfer device is padded at specified load bearing points along the body for increased personal comfort.
